(19) United States
(12) Patent Application Publication
(10) Pub. No.: US 2006/0140827 A1
(43) Pub. Date: Jun. 29, 2006

(54) Concentration difference photochemical reactor

(76) Inventors: Kong-Wei Cheng, Hsinchu (TW); Jau-Chyn Huang, Hsinchu (TW); Ching-Sung Hsiao, Hsinchu (TW); Pei-Shan Yen, Hsinchu (TW)

Correspondence Address: RABIN & Berdo, PC, 1101 14TH STREET, NW, SUITE 500, WASHINGTON, DC, 20005, US

(21) Appl. No.: 11/159,333

(22) Filed: Jun. 23, 2005

(30) Foreign Application Priority Data
Dec. 27, 2004 (TW) 93140754

(51) Int. Cl. B01J 19/08; B01J 19/12

(52) U.S. Cl. 422/186; 422/186.3

(57) ABSTRACT

A concentration difference photochemical reactor includes of a photochemical reaction tub and a photocatalyst reaction plate. The photocatalyst reaction plate is formed by combining in sequence a photocatalyst, a metal, a conductive carrier, and a reduction electrode to reduce its internal resistance barrier and increase the electron-hole separation rate excited by photons. By adjusting the concentration difference in the solutions inside the photochemical reaction tub, the location of chemical reactions is changed to increase the efficiency and reduce the use of a sacrificing reagent without the restrictions of thermodynamics.

### BACKGROUND OF THE INVENTION

1. Field of Invention

The invention relates to a photochemical reactor and, in particular, to a concentration difference photochemical reactor.

2. Related Art

Solar energy is an important energy source on Earth. It is estimated that the energy received on the surface of the Earth is about 3.0×10²⁴ J per year. The required energy for photosynthesis is about 3.0×10²¹ J per year. The consumption of fossil energy is about 2.8×10²⁰ J per year. Therefore, most of the energy from the solar system is still unused. How to improve the efficiency of solar energy will have significant impacts on human energy expenditure.

Currently, most of the solar energy techniques focus on the solar thermal energy and solar cells. Taking the decomposition of water into H₂ and O₂ as an example, 10˜15% of solar energy conversion is necessary according to the economical requirement, therefore the energy gap of the photocatalyst needs to be in the range of 2.0˜2.5V. Using published sulfur-series photocatalysts, the energy gap has been able to reach 2.0V. Thus, the materials have achieved economical values. However, the conduction band and valance band are too negative. Their oxidation ability is inferior while their reduction ability is stronger. It is often necessary to add in extra sacrificing reagents, such as K₂SO₃ and CH₃OH. For the water splitting process, the original oxidation reaction has to be replaced by another relation. For example, the SO₃²⁻ undergoes a reaction with water to generate an SO₄²⁻ and an H⁺. As a by-product of the reaction, a lot of useless ions are generated. This complicates the future processing procedure.

Besides, to make the photocatalyst chemical process reach commercialization, the structure and design of photochemical reactors have to be devised. The upper limit of thermodynamics is the point of the invention. Therefore, how to make a photochemical reactor to adjust the reaction state so that the reaction is not limited by thermodynamics is a challenge of the field.

### SUMMARY OF THE INVENTION

In view of the foregoing, an objective of the invention is to provide a concentration difference photochemical reactor. Using a special shape of the photocatalyst reaction plate and the method of adjusting the concentration difference, the efficiency of photochemical reaction rate can be enhanced. The use of a sacrificing reagent can be reduced. Therefore, the invention can solve the problems existing in the prior art.

To achieve the above objective, the disclosed concentration difference photochemical reactor is comprised of a photochemical reaction tub and a photocatalyst reaction plate installed therein. The photochemical reaction is filled with more than one solution for the reactants. It further has an oxidation tub and a reduction tub. The operating conditions of the photochemical reaction tub are adjusted to break the limitation of thermodynamics. The pH value of the solution in the oxidation tub is kept between 6 and 11, the pH value of the solution in the reduction tub is kept between 2 and 7, and the pH value of the former is always higher than that of the latter. Besides, the photocatalyst reaction plate contains in sequence a photocatalyst, a metal, conductive carrier, and a reduction electrode. The photocatalyst and the reduction electrode are disposed respectively in the oxidation tub and the reduction tub. The photocatalyst can absorb optical energy to excite electron-hole pairs. The metal is used to reduce the internal resistance of electron transmissions in the photocatalyst, preventing the electrons and holes from recombination. The separation rate of electron-hole is therefore enhanced. The conductive carrier is employed to be the substrate of the photocatalyst and transfer the electrons to the reduction electrode to carry out reduction reactions. Of course, aside from separating the electron-hole pairs, the oxidation and reduction reactions happen at different places, avoiding a separation process.

### BRIEF DESCRIPTION OF THE DRAWINGS

The invention will become more fully understood from the detailed description given hereinbelow illustration only, and thus does not limit the present invention, wherein:

FIGS. 1A and 1B are side and top cross-sectional views of the disclosed concentration difference photochemical reactor;

FIGS. 2A and 2B are side and top cross-sectional views of another type of a concentration difference photochemical reactor according to the invention; and

FIG. 3 is a diagram showing the production of H₂ and O₂ in the second embodiment of the invention.

### DETAILED DESCRIPTION OF THE INVENTION

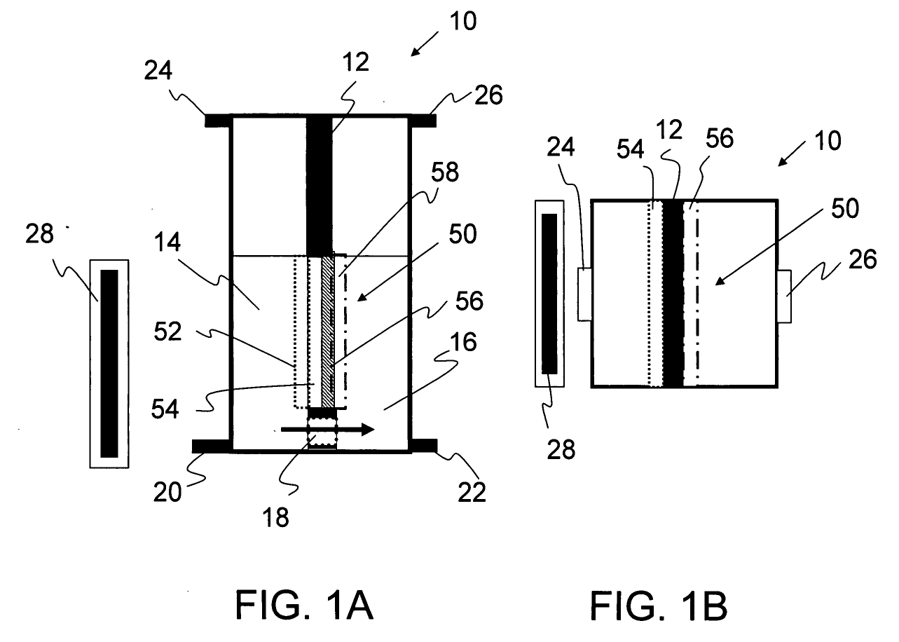

FIGS. 1A and 1B are respectively side and top cross-sectional views of the disclosed concentration different photochemical reactor. The concentration different photochemical reactor is mainly comprised of a photochemical reaction tub 10 and a photocatalyst reaction plate 50. The photochemical reaction tub 10 has more than one solution for the reactants. A reaction separation plate 12 is used to divide the photochemical reaction tub 10 into an oxidation tub 14 and a reduction tub 16. The pH value of the solution in the oxidation tub 14 is kept between 6 and 11, the pH value of the solution in the reduction tub 16 is kept between 2 and 7, and the pH value of the former is always higher than that in the latter. The reaction separation plate 12 is installed with the photocatalyst reaction plate 50. The photocatalyst reaction plate 50 is formed by combining in sequence a photocatalyst 52, a metal 54, conductive carrier 56 and a reduction electrode 58. The photocatalyst 52 and the reduction electrode 58 are disposed respectively inside the oxidation tub 14 and the reduction tub 16 of the photochemical reaction tub 10. The lowest part of the reaction separation plate 12 is a separation membrane 18 for specific ions to pass through. The exterior of the photochemical reaction tub 10 has reactant inlets 20, 22 and product outlets 24, 26 as the input channels for replenishing reactants and the output channels for removing products. Moreover, a light source 28 provides the required optical energy to the photocatalyst. It is a parallel light source, which can be provided by artificial light or sunlight.

When the light source 28 is put into the oxidation tub 14 for the oxidation reaction, the design of the photocatalyst reaction plate 50 can move the optically excited holes into the oxidation tub 14 for relevant reactions to obtain oxidation products. One product of the oxidation reaction penetrates through the separation membrane 18 into the reduction tub 16 under an appropriate osmotic pressure. It obtains electrons from the reduction electrode 58 on the photocatalyst reaction plate 50 to produce products of the reduction reaction.

In the following, we describe in further detail the theoretical basis of the invention and how to make such a concentration difference photochemical reactor.

The main body of the invention is the photochemical reaction tub 10. The photocatalyst reaction plate 50 and the reaction separation plate 12 are employed to separate the oxidation and reduction reactions. Through changes in the operating conditions, the amount of extra sacrificing reagents is reduced. Here the pH value of the solution in the oxidation tub 14 is adjusted to be high, so that the energy gap of the oxidation reaction is higher than the valence band gap in order to satisfy the thermodynamical requirement. The optically excited electrons are moved into the reduction tub 16, reducing the pH value of the solution therein. The potential of the reduction reaction is lowered so that the oxidation and reduction energy gaps in the reactions are between the conduction band and the valence band of the photocatalyst 52. Moreover, the sulfur-series photocatalyst can be adjusted using the S²⁻ ion.

In particular, the pH value of the solution in the oxidation tub 14 has to be higher than that of the solution in the reduction tub 16. The difference is between 1 and 8. For the water splitting process, if the pH value of the solution in the oxidation tub 14 is higher than that of the solution in the reduction tub 16, the difference varies for different photocatalysts 52. For example, the pH difference of TiO₂ has to be kept above 5, the pH difference of AgInZn₇S₉ is 2, while the methane synthesis from carbon dioxide using TiO₂ should keep a pH value above 2. If the pH value of the solution in the oxidation tub 14 is 6, the pH value of the solution in the reduction tub 16 can be 4. In this case, the reaction can happen without the limitation of thermodynamics. At the same time, extra ions, such as Na⁺ and SO₄²⁻can be added to adjust the osmotic pressure, ensuring that the reacting ions do not experience any osmotic resistance in the separation membrane 18 and no extra ions are produced during the reaction. Therefore, the reaction status can be stabilized.

Besides, both the oxidation tub 14 and the reduction tub 16 need to be replenished with reactants in order to keep the reactant concentration stable. The input of the reactants can be supplied by steel pipes, plastic pipes, or a pump along with a pressure pipe to the reactant inlets 20, 22. The reactants are replenished to maintain the stability of the interior concentration, pressure, and osmotic pressure.

Moreover, the reaction separation plate 12 that divides the photochemical reaction tub 10 into an oxidation tub 14 and a reduction tub 16 is also used for the supporting carrier of the photocatalyst reaction plate 50 and the separation membrane 18. The material has to be stable in the oxidation tub 14 and the reduction tub 16. One may use a stable metal, a polymer with high strength, or a metal or polymer with a protection structure.

The separation membrane 18 on the reaction separation plate 12 has a mesh or a large area. Its primary function is to let specific ions or chemical substances in the oxidation tub 14 pass through. It also separates the oxidation tub 14 and the reduction tub 16. Only specific substances are allowed to pass through to participate in relevant reactions. It can reduce the separation step. The osmotic pressures of the oxidation tub 14 and the reduction tub 16 have to be adjusted in advance in order to reduce the resistance in the separation membrane and to allow the ions or reactants to pass through.

The photocatalyst reaction plate 50 can be formed in a mesh or a large area structure on the reaction separation plate 12. It consists of four parts, respectively the photocatalyst 52, the metal 54, the conductive carrier 56, and the reduction electrode 58. Each part can be combined in a thin film or dense granules. The photocatalyst 52 is in contact with the oxidation tub 14 and the reduction electrode 58 is in contact with the reduction tub 16 for chemical reactions.

The primary function of the photocatalyst 52 is to form electron-hole pairs that have oxidation and reduction abilities after being exposed to light. Since the electron-hole pairs have to move to surfaces in order to participate in chemical reactions, a metal 54 in the ohmic contact has to be provided between the photocatalyst 52 and the conductive carrier 56 to reduce the internal resistance. It can reduce the recombination of electron-hole pairs. The conductive carrier 56 is connected to the reduction electrode 58 for the convenience of the holes to move to the surface of the photocatalyst 52 and the electrons to move to the surface of the reduction electrode 58. In addition to separating electrons and holes, it further lets the oxidation and reduction reactions happen in different parts to avoid a separation process. Moreover, the reduction electrode 58 is mainly used for the reduction reaction. The oxidation reaction happens on the photocatalyst 52. After the photocatalyst 52 absorbs optical energy, electron-hole pairs are produced. The holes move to the surface of the photocatalyst 52, while the electrons move via the metal 54 and the conductive carrier 56 to the reduction electrode 58. The holes on the photocatalyst 52 undergo an oxidation reaction with the reactants in the oxidation tub 14 due to its extreme instability. For example, the water is decomposed into O₂, H⁺, and electrons. The electrons released from the oxidation reaction are combined with the holes. The ionic products of the reactants penetrate through the separation membrane and move to the reduction tub 16, in which the ionic products have contact with the optically excited electrons on the reduction electrode 58. The reduction reaction produces electrons. Therefore, the ionic products are reduced back to molecules. For example, these H⁺ are reduced to H₂.

The photocatalyst 52 is a semiconductor material. After the optical excitation, electron-hole pairs are produced. The oxidation power of the holes and the reduction power of the electrons can induce appropriate chemical reactions. The photocatalyst 52 can be in the oxygen series, the sulfur series, the gallium series, or the silicon series that receive visible and ultraviolet (UV) light, e.g. TiO₂, ZnO, ZnS, CdS, ZnSe, CdSe, WO₃, GaAs, GaP, AgInZn₇S₉,(CuIn)_{0.15}In_{0.3}Zn_{1.4}S₂, etc, or their solid-solution photocatalyst.

The metal 54 between the conductive carrier 56 and the photocatalyst 52 has to be a metal in ohmic contact. It varies for different photocatalyst materials. The Fermi level of an n-type semiconductor photocatalyst 52 has to be lower than the work function of the metal 54. The Fermi level of a p-type semiconductor photocatalyst 52 has to be higher than the work function of the metal 54. If it is impossible to obtain a stable metal material under normal temperatures (e.g. it is hard for magnesium to maintain its metal state in air), one may use a metal 54 formed with the Schottky barrier. However, it should be noted that the work function of the metal 54 cannot be too far from the Fermi level of the photocatalyst 52. One should choose an appropriate metal 54 in order to form the metal contact with a low Schottky barrier.

The conductive carrier 56 is mainly used as a support of the photocatalyst 52 and as the transmission channel of optical excited electrons. It can be a conductive metal or substance such as copper, silver, gold, platinum, and ITO glass.

The reduction electrode 58 is a metal with a low over-potential in the reduction reaction. This can reduce the internal resistance dissipation in the reduction reaction. For example, when these H⁺ react to generate, the H₂, Pt or both Ru and Pt can be distributed in a mesh. Normally, the reduction electrode can be formed by distributing a material with high reactivity and low over-potential (e.g. Pt, Ru, Ni, NiO, and RuO₂) in a large area or distributing at least two reduction substances in a mesh over the conductive carrier 56.

Since the photocatalyst requires a light source 28 to induce electron-hole pairs, the photocatalyst reaction plate 50 and the reaction separation plate 12 can be installed in the vicinity of the light source 28 to minimize energy loss. The light source 28 for the photocatalyst can be UV, visible, infrared (IR), or other kinds of light provided by an artificial light source or sunlight. The incident light can be parallel light from an inner tube set inside the oxidation tub or a fiber set with side illumination.

Beside, if the incident light source 28 is a parallel beam, the oxidation tub 14 has to use a transparent material in order to make the light reach the photocatalyst 52 to induce chemical reactions. The material can be acryl, glass, quartz glass, etc. The reduction tube does not need a light source. Its material can be a metal, polymer, quartz glass, glass, plastic, etc.

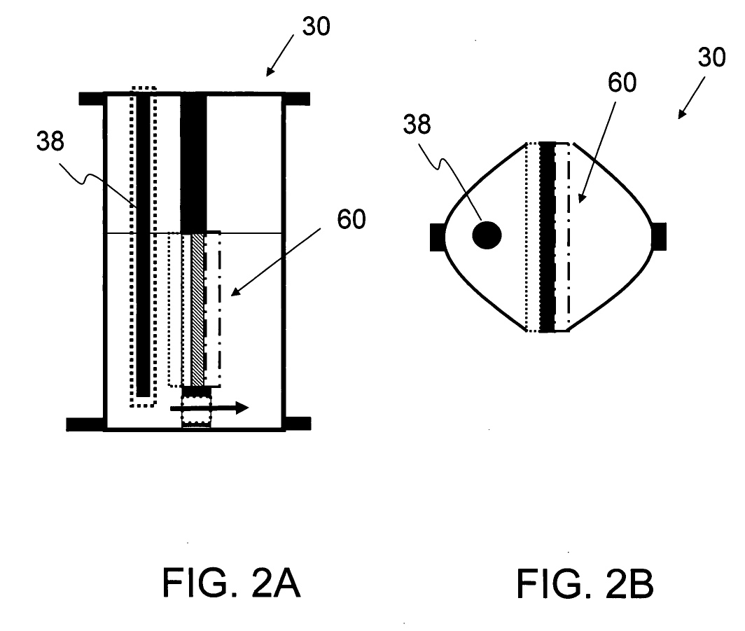

The photochemical reaction tub 10 can have the shape of a square, rectangle, paraboloid, ellipsoid, etc. The tube light source or side-illuminating fiber tube can be distributed in parallel inside the photochemical reaction tub 10 or on the focal point of the paraboloid or ellipsoid. As shown in FIGS. 2A and 2B, the light source 38 of the photochemical reaction tub 30 is transmitted from a tube artificial light source or sunlight through a fiber to the side-illuminating fiber as the light source of the photocatalyst reaction plate 60. In this case, the photochemical reaction tub 30 can have the shape of a paraboloid or ellipsoid. The fiber or tube light source can be disposed on the focal point of the photochemical reaction tub 30 to enhance the optical energy distribution and energy transmission.

In the following, the disclosed concentration difference photochemical reactor is demonstrated in two embodiments, in which a TiO₂ photocatalyst and a sulfur-series photocatalyst are respectively used for a water splitting process.

### EMBODIMENT 1

(1) Design of the photocatalyst reaction plate: The TiO₂ photocatalyst has a valence band of 3.0V (SHE) and a conduction band of −0.2V (SHE). It is equivalent to the vacuum potential −7.5V (valance band) and −4.3V (conduction band). The Fermi level of TiO₂ is about −4.37. Therefore, if one uses aluminum (with a work function ˜4.28V) or silver (with a work function ˜4.26V), then an ohmic contact can be formed with TiO₂. If copper (with a work function ˜4.65V) is used instead, a Schottky barrier will be formed. If iron (with a work function ˜4.5V) is used, then a smaller Schottky barrier is formed. Therefore, it is preferable to use aluminum or silver. If AgInZn₇S₉ is used, its conduction band is −3.61V, its valence band is −5.91V, and its Fermi level is about −3.7V. Therefore, one can use magnesium (with a work function ˜3.66V) as the ohmic contact metal. However, since magnesium is unstable in O₂, it is difficult to obtain pure magnesium. Thus, one may use aluminum or silver instead. Although a Schottky barrier will be formed, it is closer to −3.7 and normally stable. In this embodiment, aluminum is used because silver is more expensive.

(2) Selection of the reaction state: Normal photochemical reactions happen under room temperatures. However, a separation process is required. The invention can separate different tubs for oxidation and reduction reactions. One can obtain O₂ from the oxidation tub and H₂ from the reduction tub. Since the external pressure is 1 atm, the photochemical reaction tub has to have a pressure of at least 1 atm in order to avoid using a pumping device. When TiO₂ reacts at room temperatures and a pressure of 1 atm in the reactor, its valence band is always lower than the oxidation reaction, satisfying the thermodynamics requirements. However, its conduction band is lower than the reduction potential requirement. Therefore, no reaction happens. If the photocatalyst can be placed at a place with pH=5, the electrons and holes in optically excited electron-hole pairs are moved respectively to the reduction electrode and the surface of the photocatalyst. Since the whole potential satisfies the thermodynamics requirement, the oxidation reaction produces O₂. The electrons on the reduction electrode still maintain the potential of pH=5. If the solution of the reduction tub has pH=0, then the thermodynamics requirement is met for having reduction reactions.

Consequently, this embodiment designs the photocatalyst reaction plate to be TiO₂/Al/Cu/Pt. The pH value of the solution in the oxidation tub is 9, and that of the solution in the reduction tub is about 4. A parallel light source is employed. The shape of the concentration difference photochemical reactor is shown in FIGS. 1A and 1B. If a tube light source is used instead, the shape shown in FIGS. 2A and 2B can be used to decompose water into H₂ and O₂.

### EMBODIMENT 2

(1) Design of the photocatalyst reaction plate: In this embodiment, AgInZn₇S₉ is used as the photocatalyst, with a conduction band of −3.61V, a valence band of −5.91V, and a Fermi level of about −3.7V. Therefore, magnesium (with a work function ˜3.66V) can be used as the ohmic contact metal. However, since magnesium is unstable in O₂, it is difficult to obtain pure magnesium. Thus, one may use aluminum (with a work function ˜4.28V) or silver (with a work function ˜4.26V) instead. Although a Schottky barrier will be formed, it is closer to −3.7 and normally stable. In this embodiment, aluminum is used because silver is more expensive. Using Ni/NiO to replace Pt is also a result of expense consideration.

(2) Selection of the reaction state: Normal photochemical reactions happen under room temperatures. However, a separation process is required. The invention can separate different tubs for oxidation and reduction reactions. One can obtain O₂ from the oxidation tub and H₂ from the reduction tub. Since the external pressure is 1 atm, the photochemical reaction tub has to have a pressure of at least 1 atm in order to avoid using a pumping device, since the valence band is higher than the oxidation reaction. The thermodynamical requirement is not met and no reaction happens. A sacrificing reagent has to be added for replacing the oxidation reation (with a suggestive overpotential value of 0.5 V in the literature taken into account). If the photocatalyst thin film is disposed at a place with pH=8, the electrons and holes in the optically excited electron-hole pairs are moved to the reduction electrode and the surface of the photocatalyst respectively. Since when pH=8, the potential of the oxidation reaction is higher than the hole potential to satisfy the thermodynamics requirement. Therefore, the oxidation reaction produces O₂. The electrons on the reduction electrode still have the potential of pH=8. If the solution in the reduction tub has pH=5, the potential of the reduction reaction is reduced to satisfy the thermodynamics requirement. Consequently, the reduction reaction can happen without adding any sacrificing reagent.

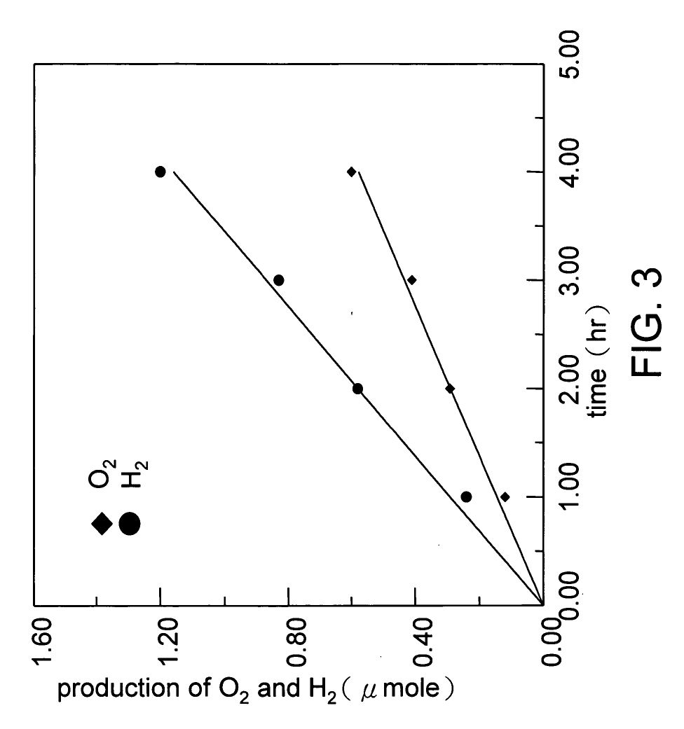

Therefore, the photocatalyst reaction plate is designed to be AgInZn₇S₉/Al/Cu/Ni/NiO. The solution in the oxidation tub has pH=8 and the solution in the reduction tub has pH that is about 5. A parallel light source is used to decompose water into H₂ and O₂. It is found that using the photocatalyst reaction plate without a sacrificing reagent, most bubbles are produced on the surface of NiO, which means that the reduction reaction happens at the reduction electrode. It proves that our idea is correct. The experimental data of this type of concentration difference photochemical reactor are shown in FIG. 3.

In summary, the disclosed concentration difference photochemical reactor implements the theory of thermodynamics and semiconductor chemistry to increase the electron-hole separation rate using the photocatalyst reaction plate and the adjustment of concentration. Under the conditions of reducing the uses of the sacrificing reagent, the subsequent reaction waste processing procedure, and the equipment, the reaction rate of the photocatalyst chemical reaction can still be maintained. This has great implications for future energy generations and use.

Besides, the invention can directly separate the products obtained in the oxidation and reduction reactions without using an extra separation device. It solves the problem of requiring an additional separation device in the usual photocatalyst powder reactor. Moreover, the invention can be applied to specific chemical substances or energy fields. For example, it can be used to decompose water to generate the H₂, to turn carbon dioxide into an energy-generating fuel, to convert wastes, or it can be used in a reaction device for other chemical reactions, thus providing another application for the solar energy and hydrogen energy.

Certain variations could be apparent to those skilled in the art, which variations are considered within the spirit and scope of the claimed invention.

What is claimed is:

1. A concentration different photochemical reactor, comprising:
a photochemical reaction tub, which has more than one solution for reactants, an oxidation tub, and a reduction tub, the solution in the oxidation tub having pH=6˜11, the solution in the reduction tub having pH=2˜7, and the pH value of the former is higher than the pH value of the latter; and
a photocatalyst reaction plate, which is installed in the photochemical reaction tub and has in sequence:
a photocatalyst, which is provided in the oxidation tub to receive optical energy, to generate a plurality of electron-hole pairs, and to have the holes participate an oxidation reaction;
a metal, which is connected to the photocatalyst to form a low contact resistance with the photocatalyst, preventing the electrons and the holes from recombination;
a conductive carrier, which is connected to the metal for transmitting the electrons; and
a reduction electrode, which is provided in the reduction tub and connected to the conducive carrier to receive the electrons and to have the electrons participate in a reduction reaction.

2. The concentration different photochemical reactor of claim 1 further comprising a reactant inlet for replenishing the reactants consumed in the oxidation and reduction reactions.

3. The concentration different photochemical reactor of claim 1, wherein the photocatalyst, the metal, the conductive carrier, and the reduction electrode are combined in a form selected from thin films and granules.

4. The concentration different photochemical reactor of claim 1 further comprising a light source to provide the optical energy.

5. The concentration different photochemical reactor of claim 4, wherein the light source is selected from the group consisting of an artificial light source, ultraviolet (UV) light, visible light, and infrared (IR) light.

6. The concentration different photochemical reactor of claim 4, wherein the light source has a parallel incident beam.

7. The concentration different photochemical reactor of claim 6, wherein the oxidation tub is made of a transparent material.

8. The concentration different photochemical reactor of claim 6, wherein the oxidation tub is selected from the group consisting of acryl, glass, and quartz glass.

9. The concentration different photochemical reactor of claim 4, wherein the light source is selected from the types of a tube light and a side-illuminating fiber and is installed in the oxidation tub.

10. The concentration different photochemical reactor of claim 1, wherein the photocatalyst is a semiconductor material.

11. The concentration different photochemical reactor of claim 10, wherein the semiconductor material is selected from the group consisting of oxygen-series, sulfur-series, gallium-series, and silicon-series photocatalysts.

12. The concentration different photochemical reactor of claim 10, wherein the semiconductor material is selected from the group consisting of TiO₂, ZnO, ZnS, CdS, ZnSe, CdSe, WO₃, GaAs, and GaP,AgInZn₇S₉,(CuIn)_{0.15}In_{0.3}Zn_{1.4}S₂.

13. The concentration different photochemical reactor of claim 1, wherein the conductive carrier is selected from the group consisting of Cu, Ag, Au, Pt, and indium tin oxides (ITO).

14. The concentration different photochemical reactor of claim 1, wherein the metal is selected from the group consisting of an ohmic contact metal and a metal with a low Schottky barrier.

15. The concentration different photochemical reactor of claim 1, wherein the reduction electrode is made of a material selected from the group consisting of Pt, Pd, Ru, Ni, NiO, and RuO₂.

16. The concentration different photochemical reactor of claim 15, wherein the reduction electrode is installed on the conductive carrier in a fashion selected from a large area style and a mesh style.

17. The concentration different photochemical reactor of claim 1, wherein the photochemical reaction tub also includes a reaction separation plate to divide the photochemical reaction tub into an oxidation tub and a reduction tub.

18. The concentration different photochemical reactor of claim 17, wherein the photocatalyst reaction plate is installed on the reaction separation plate in a fashion selected from a large area style and a mesh style.

19. The concentration different photochemical reactor of claim 17, wherein the photochemical reaction tub further includes a separation membrane installed on the reaction separation plate in a fashion selected from a large area style and a mesh style.

20. The concentration different photochemical reactor of claim 1, wherein the reduction tub is made of a material selected from the group consisting of metals, polymers, quartz glass, glass, and plastics.

21. The concentration different photochemical reactor of claim 1, wherein the shape of the photochemical reaction tub is selected from the group consisting of a square, a rectangle, a paraboloid, and an ellipsoid.
